(19) United States
(12) Patent Application Publication
(10) Pub. No.: US 2024/0383237 A1
(43) Pub. Date: Nov. 21, 2024

(54) FIRE-RESISTANT LIGHT-WEIGHT THERMAL INSULATION PANEL

(71) Applicant: SIKA TECHNOLOGY AG, Baar (CH)

(72) Inventors: Roy Z'ROTZ, Ebikon (CH); Herbert ACKERMANN, Tann (CH); Aline ROTZETTER, Wettingen (CH); Reto BUCHER, Kerns (CH); Robin BARMET, Sarnen (CH); Patrick HUEPPI, Stalden (CH)

(73) Assignee: SIKA TECHNOLOGY AG, Baar (CH)

(21) Appl. No.: 18/292,395

(22) PCT Filed: Aug. 5, 2022
(86) PCT No.: PCT/EP2022/072143

§ 371 Date: Jan. 26, 2024

(30) Foreign Application Priority Data
Aug. 13, 2021 (EP) 21191289.4

(51) Int. Cl. B32B 27/06; B32B 3/30; B32B 5/18; B32B 27/20; B32B 27/30; B33Y 70/10; B33Y 80/00; C04B 38/10; C04B 103/40; C04B 111/00; C04B 111/40

(52) U.S. Cl. CPC B32B 27/065; B32B 3/30; B32B 5/18; B32B 27/20; B32B 27/306; B33Y 70/10; B33Y 80/00; C04B 38/10; B32B 2266/049; B32B 2307/304; B32B 2307/72; B32B 2607/00; C04B 2103/40; C04B 2111/00181; C04B 2111/00612; C04B 2111/40; C04B 2201/20

(57) ABSTRACT

An insulation panel comprising an outer shell formed of thermoplastic material and an inner space inside the outer shell, wherein the inner space is at least partially filled with a foamed inorganic material comprising at least one mineral binder and optionally at least one synthetic organic polymer, wherein the foamed inorganic material has a density of not more than 500 g/l. The invention is also directed to a method for producing an insulation panel.

### TECHNICAL FIELD

The invention relates to the field of foamed inorganic materials and use thereof for providing thermal insulation panels. Particularly, the invention relates to prefabricated insulation panels used for improving energy efficiency of buildings structures.

### BACKGROUND OF THE INVENTION

Exterior surfaces of buildings must be protected from environmental forces such as wind and rain. Buildings must also be thermally insulated to prevent unnecessary flow of heat energy from inside to outside of the building or vice versa. Rigid prefabricated insulation panels comprising foamed synthetic organic materials, such as expanded polystyrene (EPS) foam panels, extruded expanded polystyrene (XPS) foam panels, polyurethane foam panels (PUR), and polyisocyanurate (PIR) are typically used for thermal insulation of building structures. Such materials have a very low thermal conductivity, relatively high compressive strength, and low density, typically not more than 150 g/l, which makes them ideal materials for thermal insulation applications. The major disadvantage of foamed synthetic organic materials relates to their high flammability. Due the poor fire resistance properties, the use such insulation boards in a roof assembly requires arranging additional fire proofing structures, such as fire-resistant glass scrims or glass mats, in the roofing membrane or between the roofing membrane and the insulation board. In some countries, an inflammable “fire bar” having a melting point of at least 1000° C. must be added between adjacent insulation panels in facades to fulfill the fireproof requirements.

Another disadvantage of the rigid prefabricated insulation boards is that they cannot be used for covering rounded surface shapes. The advancements in 3D printing of concrete materials enable generation of facades and roofs having unusual shapes, which cannot be thermally insulated using the State-of-the-Art rigid insulation boards. Spray applied insulation materials, such as polyurethane foams, can be easily applied to conform with any type of surface shapes. However, the thickness of spray applied layers is difficult to control, the foams contain environmentally harmful chemicals, and the foamed layers are also highly flammable.

Foamed cement and concrete compositions typically provide a combination of reduced weight and good thermal insulation properties combined with excellent fire resistance, especially when compared with foamed synthetic organic materials. Foamed concrete, also known as cellular light weight concrete (CLC), can be obtained by mixing a gas producing blowing agent, such as hydrogen peroxide or aluminum powder, into a concrete slurry or by separately producing an aqueous foam, which is then mixed with a concrete slurry. Light weight foamed concrete and other foamed mineral binder compositions have good fire resistance properties, but they also have relatively low compressive and/or bending strengths due to the brittleness of the foamed material. In order to compensate of disadvantage of poor mechanical properties, foamed concrete boards can be used in combination with foamed synthetic organic boards, typically EPS boards, to provide “lightweight insulated concrete (LWIC) systems. Mechanical properties of a foamed concrete can also be improved by increasing the density of the material, i.e., decreasing the foaming, but also results in deterioration of other properties, particularly thermal conductivity and lightweightness.

All above discussed approaches have the general disadvantage that the insulation boards cannot be used for covering irregular, particularly curved surface shapes. There thus remains a need for a novel type of insulation panel, which can be easily provided with customized shapes and, therefore, attached to any type of surface structure. The insulation panel should be lightweight, have excellent fire resistance properties, and sufficient mechanical strength, particularly in terms of compressive and bending strength.

### SUMMARY OF THE INVENTION

The object of the present invention is to provide a lightweight thermal insulation panel, which can be easily provided with customized shapes and has excellent fire resistance and mechanical properties.

Another object of the present invention is to provide a method for producing a customized thermal insulation panel based on a geometry of the surface to be covered with the insulation panel.

The subject of the present invention is an insulation panel as defined in claim 1.

It has been surprisingly found out that the objectives can be achieved with the features of claim 1.

One of the advantages of the present invention is that it enables highly efficient production of customized insulation panels having a shape that has been adapted to surface geometry of the substrate to be covered with the insulation panel.

The core of the invention is that the insulation panel comprises an outer shell having an inner space, which has been filled with a foamed inorganic material providing the insulation panel with a combination of reduced weight and excellent thermal insulation and fire resistance properties. The outer shell can be easily provided with various shapes, for example, by using additive manufacturing technologies, thus enabling variation of the shape of the insulation panel according to the surface shape of the substrate to be covered with the insulation panel.

Other subjects of the present invention are presented in other independent claims. Preferred aspects of the invention are presented in the dependent claims.

### BRIEF DESCRIPTION OF FIGURES

FIG. 1 shows an insulation panel (1) comprising an outer shell (2) and an inner space inside the outer shell (2), wherein the inner space is filled with a foamed inorganic material.

FIG. 2 shows an outer shell (2) of an insulation panel comprising an inner space inside the outer shell (2), wherein outer shell (2) comprises an opening and top and bottom walls (3, 3′) connected by first and second longitudinal side walls (4, 4′) extending in the longitudinal direction (L) of the outer shell (2), wherein the top and bottom walls (3, 3′) are corrugated over their width to have an outer surface having a plurality of convex sections.

FIG. 3 shows an outer shell (2) of an insulation panel comprising an inner space inside the outer shell (2), wherein outer shell (2) comprises an opening and top and bottom walls (3, 3′) connected by first and second longitudinal side walls (4, 4′) extending in the longitudinal direction (L) of the outer shell (2), wherein the top and bottom walls (3, 3′) are corrugated over their width to have alternating a plurality of convex and concave sections.

FIG. 4 shows a schematic representation of adjacent two insulation panels (1, 1′) having outer shells (2) of FIG. 2, which have been mated with each other via their opposing longitudinal side walls.

FIG. 5 shows a schematic representation of adjacent two insulation panels (1, 1′) having outer shells (2) of FIG. 3, which have been mated with each other via a bottom surface of the outer shell of the first insulation panel (1) and the longitudinal side wall of the outer shell of the second insulation panel (1′).

FIG. 6 shows an image of an outer shell of an insulation panel that is being produced by an additive manufacturing process.

FIG. 7 shows an image of two insulation panels having an outer shell and an inner space filled with a foamed inorganic material.

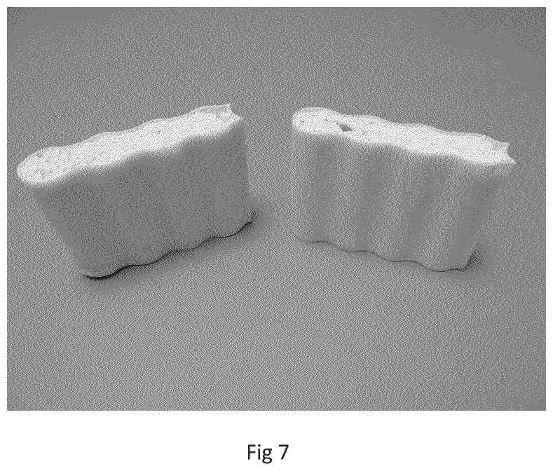

### DETAILED DESCRIPTION OF THE INVENTION

The subject of the present invention is an insulation panel (1) comprising an outer shell (2) formed of a thermoplastic material and an inner space inside the outer shell (2), wherein the inner space is at least partially filled with a foamed inorganic material comprising:
a) At least one mineral binder B and
b) Optionally at least one synthetic organic polymer SP,
wherein the foamed inorganic material has a density of not more than 500 g/l, preferably not more than 300 g/l.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomers species are called terpolymers and quaterpolymers, respectively.

The term “molecular weight” refers to the molar mass (g/mol) of a molecule or a part of a molecule, also referred to as “moiety”. The term “average molecular weight” refers to number average molecular weight (Mₙ) or to weight average molecular weight (M_{w}) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “melting temperature (Tₘ)” refers to a melting point determined as a maximum of the curve determined by means of differential scanning calorimetry (DSC) using the measurement method as defined in ISO 11357-3:2018 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The “amount or content of at least one component X” in a composition, for example “the amount of the at least one synthetic polymer” refers to the sum of the individual amounts of all synthetic polymers contained in the composition. For example, in case the composition comprises 20 wt.-% of at least one synthetic polymer, the sum of the amounts of all synthetic polymers contained in the composition equals 20 wt.-%.

The term “normal room temperature” designates a temperature of 23° C.

The insulation panel is preferably a preformed article. The term “preformed” or “prefabricated” is understood to mean that the insulation panel has been formed before being applied on a surface to be covered with the insulation panel. Particularly, the term “preformed” refers to insulation panels, which have not been formed in situ, i.e., not been formed on the surface of the substrate to be covered with the insulation panel. Such preformed insulation panels are typically, although not necessarily, fabricated at a location that is remote from the construction site, brought to the site, and laid on a surface of a substrate to be covered with the insulation panel.

The foamed inorganic material has a density of not more than 500 g/l, preferably not more than 300 g/l, more preferably not more than 250 g/l, even more preferably not more than 200 g/l, such as 25-250 g/l, preferably 35-150 g/l.

The density of the foamed inorganic material is preferably measured gravimetrically, for example by using the following procedure. A sample cube having dimensions of 10×10×10 cm is first cut from the material and dried in an oven at a temperature of 70° C. until the weight of the material remains constant. The weight of the sample cube is then measured, and the density of the material is obtained based on the measured weight and volume of the cube.

The foamed inorganic material comprises at least one mineral binder B. Suitable mineral binders include hydraulic binders, such as cement and hydraulic lime, calcium sulfates, and air-hardening binders, such as non-hydrated lime, and latent hydraulic and pozzolanic binder materials.

Hydraulic binders are inorganic materials or blends, which form a paste when mixed with water, and which set and harden by a series of hydration reactions resulting in formation of solid mineral hydrates or hydrate phases, which are not soluble in water or have a very low water-solubility. Hydraulic binders, such as Portland cement, can harden and retain their strength even when exposed to water, for example underwater or under high humidity conditions. The term “non-hydraulic binder” refers to substances, which harden by reaction with carbon dioxide and which, therefore, do not harden in wet conditions or under water.

Examples of suitable non-hydraulic binders include air-slaked lime (non-hydraulic lime) and calcium sulfate. The term “calcium sulfate” is understood to include calcium sulfate anhydride (CaSO₄), calcium sulfate hemihydrate (CaSO₄·½H₂O), and calcium sulfate dihydrate (CaSO₄·2 H₂O). Furthermore, the term “calcium sulfate hemihydrate” is understood to include both alpha and beta calcium sulfate hemihydrates. Preferred calcium sulfates include the ones derived from REA gypsum, phosphor gypsum, and nature gypsum. The term “REA gypsum” refers here to a gypsum obtained in so-called flue gas desulphurization plants.

The term “latent hydraulic binder material” refers to type II concrete additives with a “latent hydraulic character” as defined in DIN EN 206-1:2000 standard. These types of mineral binders are calcium aluminosilicates that are not able to harden directly or harden too slowly when mixed with water. The hardening process is accelerated in the presence of alkaline activators, which break the chemical bonds in the binder's amorphous (or glassy) phase and promote the dissolution of ionic species and the formation of calcium aluminosilicate hydrate phases. Examples of latent hydraulic binders include ground granulated blast furnace slag. Ground granulated blast furnace slag is typically obtained from quenching of molten iron slag from a blast furnace in water or steam to form a glassy granular product and followed by drying and grinding the glassy into a fine powder.

Term “pozzolanic binder material” refers to type II concrete additives with a “pozzolanic character” as defined in DIN EN 206-1:2000 standard. These types of mineral binders are siliceous or aluminosilicate compounds that react with water and calcium hydroxide to form calcium silicate hydrate or calcium aluminosilicate hydrate phases. Examples of pozzolanic binders include natural pozzolans, such as trass, and artificial pozzolans, such as fly ash and silica fume. The term “fly ash” refers to the finely divided ash residue produced by the combustion of pulverized coal, which is carried off with the gasses exhausted from the furnace in which the coal is burned. The term “silica fume” refers to fine particulate silicon in an amorphous form. Silica fume is typically obtained as a by-product of the processing of silica ores such as the smelting of quartz in a silica smelter which results in the formation of silicon monoxide gas and which on exposure to air oxidizes further to produce small particles of amorphous silica.

Preferably, the at least one mineral binder B comprises at least 35 wt.-%, preferably at least 50 wt.-%, more preferably at least 65 wt.-%, even more preferably at least 75 wt.-%, of the total weight of the foamed inorganic material. Generally, the expression “component X comprises Y wt.-% of the total weight of a material” is understood to mean that the weight of the component X makes up Y wt.-% of the total weight of the material.

Preferably, the at least one mineral binder B is selected from the group consisting of Portland cement, calcium aluminate cement, calcium sulfoaluminate cement, latent hydraulic binder materials, pozzolanic binder materials, calcium sulfate, and hydrated lime.

According to one or more preferred embodiments, the at least one mineral binder B comprises at least one hydraulic binder B1, preferably selected from the group consisting of Portland cement, calcium aluminate cement, and calcium sulfoaluminate cement.

Generally, the expression “the at least one component X comprises at least one component XN”, such as “the at least one mineral binder B comprises at least one hydraulic binder B1” is understood to mean in the context of the present disclosure that a composition comprises one or more hydraulic binders B1 as representatives of the at least one mineral binder B.

The term “Portland cement” as used herein is intended to include those cements normally understood to be “Portland cements”, particularly those described in European Standard EN-197. Portland cement consists mainly of tri-calcium silicate (alite) (C₃S) and dicalcium silicate (belite) (C₂S). Preferred Portland cements include the types CEM I, CEM II, CEM III, CEM IV, and CEM V compositions of the European standard EN 197-1:2018-11. However, all other Portland cements that are produced according to another standard, for example, according to ASTM standard, British (BSI) standard, Indian standard, or Chinese standard are also suitable.

The term “aluminate cement” as used herein is intended to include those cementitious materials that contain as the main constituent (phase) hydraulic calcium aluminates, preferably mono calcium aluminate CA (CaO·Al2O3). Depending on the type of the aluminate cement, other calcium aluminates, such as CA₂, C₃A, and C₁₂A₇, may also be present. Preferred aluminate cements include also other constituents, such as belite (C₂S), alite (C₃S), ferrites (C₂F, C₂AF, C₄AF), and ternesite (C₅S₂\check{\dot{S}}). Some aluminate cements also contain calcium carbonate.

Most preferred aluminate cements for use as the at least one hydraulic binder B1 include calcium aluminate cements (CAC), which fulfill the requirements of the norm EN 4647 (“Calcium Aluminate Cement”). Suitable calcium aluminate cements are commercially available, for example, from Imerys Aluminates and Royal White Cement.

The term “calcium sulfoaluminate cement (CSA)” is intended to include those cementitious materials that contain as the main constituent (phase) C4(A3-xFx)3\check{\dot{S}} (4CaO·3-x Al₂O₃·x Fe2O3·CaSO4), wherein x has a value of 0, 1, 2, or 3. Typically, calcium sulfoaluminate cements also include other constituents, such as aluminates (CA, C₃A, C₁₂A₇), belite (C₂S), ferrites (C₂F, C₂AF, C₄AF), ternesite (C₅S₂\check{\dot{S}}), and calcium sulfate. Preferred calcium sulfoaluminate cements for use as the at least one hydraulic binder B1 contain 20-80 wt.-% of ye'elimite (C4A3\check{\dot{S}}), 0-10 wt.-% of calcium aluminate (CA), 0-70 wt.-% of belite (C₂S), 0-35 wt.-% of ferrite, preferably tetracalcium aluminoferrite (C₄AF), and 0-20 wt.-% of ternesite (C5S2\check{\dot{S}}), based on the total weight of the calcium sulfoaluminate cement. Suitable calcium aluminate cements (CAS) are commercially available, for example, from Heidelberg Cement AG, Vicat SA, and Caltra B.V.

Preferably, the at least one hydraulic binder B1 comprises at least 50 wt.-%, more preferably at least 65 wt.-%, even more preferably at least 75 wt.-%, of the total weight of the at least one mineral binder B. According to one or more embodiments, the at least one mineral binder B is a hydraulic binder, preferably selected from the group consisting of Portland cement, calcium aluminate cement, and calcium sulfoaluminate cement, preferably Portland cement.

According to one or more embodiments, the weight ratio of the amount of the at least one mineral binder B to the amount of the at least one synthetic polymer SP in the foamed inorganic material is from 100:0 to 70:30, preferably from 100:0 to 80:20.

According to one or more embodiments, the proportion of the at least one synthetic polymer SP is 1-25 wt.-%, preferably 5-15 wt.-%, more preferably 8-12 wt.-%, with respect to the weight of the at least one mineral binder B in the foamed inorganic material.

The at least one synthetic organic polymer SP may be used to improve mechanical properties, particularly the compressive strength and/or bending strength, of the foamed inorganic material.

The type of the synthetic polymer SP is not particularly restricted. Suitable synthetic organic polymers include, for example, polyurethane polymers and homopolymers and copolymers obtained from free radical polymerization of one or more monomers selected from the group consisting of ethylene, propylene butylene, isoprene, butadiene, styrene, acrylonitrile, (meth)acrylic acid, (meth)acrylate, vinyl ester, vinyl neodecanoate, vinyl alcohol, and vinyl chloride. The term “(meth)acrylate” refers to acrylate and methacrylate and term “(meth)acrylic” refers to acrylic and methacrylic.

The term “polyurethane polymer” refers polymers prepared by so called diisocyanate polyaddition process, including those polymers which are almost or completely free of urethane groups. Examples of suitable polyurethane polymers include polyether polyurethanes, polyester polyurethanes, polyether polyureas, polyureas, polyester polyureas, polyisocyanurates, and polycarbodiimides.

According to one or more embodiments, the at least one synthetic organic polymer SP is a polyurethane polymer, preferably based on at least one polyisocyanate and at least one polyol and/or polyamine monomer.

Suitable polyisocyanates include monomeric polyisocyanates, as well as oligomers, polymers, and derivatives of monomeric polyisocyanates, and mixtures thereof.

Suitable monomeric polyisocyanates for polyurethane polymers include at least aromatic di- and tri-functional isocyanates, such as 2,4- and 2,6-toluylendiisocyanate and mixtures of its isomers (TDI), 4,4′-, 2,4′- and 2,2′-diphenylmethandiisocyanate and mixture of its isomers (MDI), 1,3- and 1,4-phenylendiisocyanate, 2,3,5,6-tetramethyle-1,4-diisocyanatobenzol, naphthaline-1,5-diisocyanate (NDI), 3,3′-dimethyl-4,4′-diisocyanatodiphenyl (TODI), dianisidindiisocyanate (DADI), 1,3,5-tris-(isocyanatomethyl)benzene, tris-(4-isocyanatophenyl)methane and tris-(4-isocyanatophenyl) thiophosphate.

Further suitable monomeric polyisocyanates for polyurethane polymers include aliphatic di- and tri-functional isocyanates, such as 1,4-tetramethylendiisocyanat, 2-methylpentamethylene-1,5-diisocyanate, 1,6-hexamethylendiisocyanate (HDI), 2,2,4- and 2,4,4-trimethyl-1,6-hexa-methylendiisocyanate (TMDI), 1,10-decamethylendiisocyanate, 1,12-dodecame-thylendiisocyanat, lysin- and lysinesterdiisocyanate, cyclohexane-1,3- and -1,4-diisocyanate, 1-methyl-2,4- and -2,6-diisocyanatocyclohexane and mixtures of its isomers (HTDI or H6TDI), 1-isocyanato-3,3,5-trimethyl-5-iso-cyanatomethyl-cyclohexane (=isophorondiisocyanate or IPDI), perhydro-2,4′- and -4,4′-diphenylmethandiisocyanate (HMDI or H12MDI), 1,4-diisocyanato-2,2,6-trimethylcyclohexane (TMCDI), 1,3- and 1,4-Bis-(isocyanatomethyl)cyclo-hexane, m- and p-xylylendiisocyanate (m- and p-XDI), m- and p-tetramethyle-1,3- and -1,4-xylylendiisocyanate (m- and p-TMXDI), bis-(1-isocyanato-1-methyl-ethyl)naphthaline, dimer- and trimer fatty acid isocyanate such as 3,6-bis-(9-isocya-natononyl)-4,5-di-(1-heptenyl)cyclohexen (dimeryldiisocyanat) and α, α, α′, α′, α″, α″-hexamethyl-1,3,5-mesitylentriisocyanate.

Particularly suitable polyols for polyurethane polymers include polyether polyols, polyester polyols, polycarbonate polyols, poly(meth)acrylate polyols, and hydrocarbon polyols, such as polybutadiene polyols, polyhydroxy functional fats and oils, and polyhydroxy functional acrylonitrile-butadiene copolymers.

Particularly suitable polyether polyols include polyoxyalkylene diols and/or polyoxyalkylene triols, especially the polymerization products of ethylene oxide or 1,2-propylene oxide or 1,2- or 2,3-butylene oxide or oxetane or tetrahydrofuran or mixtures thereof, which can be polymerized with using a starter molecule having two or three active hydrogen, in particular one, such as water, ammonia or a compound with several OH or NH groups, such as 1,2-ethanediol, 1,2- or 1,3-propanediol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, 1,3- or 1,4-cyclohexanedimethanol, bisphenol A, hydrogenated bisphenol A, 1,1,1-trimethylolethane, 1,1,1-trimethylolpropane, glycerol or aniline, or mixtures of the aforementioned compounds.

Suitable polyester polyols include liquid polyester polyols as well as amorphous, partially crystalline, and crystalline polyester polyols, which are solid at a temperature of 25° C. These can be obtained from by reacting dihydric and trihydric, preferably dihydric, alcohols, for example, 1,2-ethanediol, diethylene glycol, triethylene glycol, 1,2-propanediol, 1,3-propanediol, dipropylene glycol, 1,4-butanediol, 1,5-pentanediol, 1,6-hexanediol, 1,8-octanediol, 1,10-decanediol, 1,12-dodecanediol, dimer fatty alcohol, neopentyl glycol, glycerol, 1,1,1-trimethylolpropane or mixtures of the aforesaid alcohols, with organic dicarboxylic acids or tricarboxylic acids, preferably dicarboxylic acids, or their anhydrides or esters, such as succinic acid, glutaric acid, 3,3-dimethylglutaric acid, adipic acid, suberic acid, sebacic acid, undecanedioic acid, dodecanedicarboxylic acid, azelaic acid, maleic acid, fumaric acid, phthalic acid, dimer fatty acid, isophthalic acid, terephthalic acid, and hexahydrophthalic acid, or mixtures of the aforesaid acids, and also polyester polyols made from lactones such as from s-caprolactone, for example, also known as polycaprolactones.

Suitable polyamine monomers are compounds having two or more isocyanate reactive amine groups. Examples of employable polyamine monomers include diethyltolylenediamine, methylbis(methylthio)phenylenediamine, adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-aminoethyl)-2-aminoethanol, polyoxyalkyleneamine, adducts of salts of 2-acrylamido2-methylpropane-1-sulfonic acid (AMPS) and ethylenediamine, adducts of salts of (meth)acrylic acid and ethylendiamine, adducts of 1,3-propanesulfone and ethylenediamine or any desired combination of these polyamines.

According to one or more preferred embodiments, the at least one synthetic organic polymer SP is selected from the group consisting of polyacrylates, styrene-acrylate copolymers, polyvinyl esters, ethylene-vinyl acetate copolymers, ethylene-vinyl alcohol copolymers, styrene-butadiene copolymers, vinyl acetate-vinyl neodecanoate (VeoVa) copolymers, and polyurethane polymers.

According to one or more preferred embodiments, the at least one synthetic organic polymer SP comprises at least one ethylene-vinyl acetate copolymer and/or at least one terpolymer of ethylene, vinyl acetate, and vinyl ester monomers.

Especially suitable ethylene-vinyl acetate copolymers for use as the at least one synthetic organic polymer SP have a content of a structural unit derived from vinyl acetate of not more than 40 wt.-%, preferably not more than 30 wt.-%, more preferably not more than 20 wt.-%, still more preferably not more than 15 wt.-%, based on the weight of the copolymer.

According to one or more embodiments, the foamed inorganic material further comprises at least one surfactant S. The term “surfactant” refers here to surface tension lowering substances, which are usually organic compounds containing both hydrophobic and hydrophilic groups.

Surfactants may be used to stabilize the foam structure during preparation of the foamed inorganic material.

Surfactants are well known to the specialist and are summarized, for example, in “Surfactants and Polymers in aqueous solutions” (Wiley-VCH, K. Holmberg et al, 2^{nd} Edition, 2007). Suitable surfactants include at least non-ionic surfactants, cationic surfactants, anionic surfactants, and amphoteric surfactants. Amphoteric (zwitterionic) surfactants have both cationic and anionic centers attached to the same molecule.

It may be particularly advantageous to use non-ionic surfactants since they have a low tendency to be absorbed by cement phases. However, it is also possible to use cationic, anionic or amphoteric (zwitterionic) surfactants.

Suitable surfactants in the context of the present invention include lipids such as cholates, glycocholates, fatty acid salts, glycerides, glycolipids, and phospholipids. These may be derived from natural sources or may be synthetically produced. Non-ionic lipids are preferred in certain embodiments.

Suitable anionic surfactants include compounds containing carboxylate, sulfate, phosphate, or sulfonate groups, such as organosulfates, alkyl ether carboxylates, alkyl sulfates, alkyl ether sulfates, fatty alcohol sulfates, alkyl sulfosuccinates, alkylphenol ethoxylates, olefinsulfonates, alkyl phosphates, alkyl ether phosphonates, and alkyl benzene sulfonates.

Suitable non-ionic surfactants include, particularly, fatty acid alkoxylates, alkoxylated alcohols, especially fatty acid alcohol alkoxylates and alkoxylates of glycerol and pentaerythritol, alkylphenol alkoxylates, alkoxylated polysaccharides, alkoxylated polycondensates, fatty acid amide alkoxylates, ethanolamides, esters of fatty acids, especially fatty acid esters of methanol, sorbitan, glycerol or pentaerythritol, alkoxylated alkylamines with an alkyl radical consisting of 6-20 carbon atoms, alkyl glycosides, alkyl glucamides, esters of fatty acids and sugars, polysiloxanes, as well as alkoxylated sorbitans, copolymers of ethylene oxide and propylene oxide, lauryl ether sulphonates, naphthalene sulphonates, hydrophobized starch, hydrophobized cellulose or siloxane-based surfactants. Preferred alkoxylates in this context are particularly ethoxylates.

Suitable cationic surfactants contain particularly ammonium groups or quaternary nitrogen atoms and have at least one long-chain alkyl radical. Examples of suitable cationic surfactants are quaternary ammonium compounds with at least one alkyl group, phosphonium compounds, such as tetraalkylammonium salts, imidazolines, such as N,N-dialkylimidazoline compounds, dimethyldistearylammonium compounds, N-alkylpyridine compounds, ammonium chlorides, and amine N-oxides. For example, a cationic surfactant can be chosen from tetradecyltrimethylammonium bromide (TTAB), Cetyltrimethylammonium bromide (CTAB), and Dodecyltrimethylammonium bromide (DTAB).

According to one or more embodiments, the at least one surfactant S comprises or consist of at least one Gemini surfactant.

Gemini surfactants contain two hydrophilic head groups and two hydrophobic tails separated by a spacer at or near the head groups. When both hydrophobic tails are the same and the hydrophilic groups are identical, Gemini surfactants are said to have a symmetrical structure. The substituents in Gemini surfactants are largely responsible for the behavior of these compounds in solution and their potential applications. Particularly, Gemini surfactants may contain quaternary nitrogen atoms, which are usually present in acyclic forms. However, there are also Gemini surfactants that contain nitrogen in saturated and unsaturated rings. The spacer can be either rigid or flexible, tending to be hydrophobic or hydrophilic. The special properties of Gemini surfactants can be influenced by optimizing the hydrophilic-lipophilic balance (HLB value). This can be done, for example, by introducing

balanced polar or hydrophobic groups in both head groups, tails or spacers. Examples of preferred Gemini surfactants are particularly alkoxylated
acetyldiols or Gemini surfactants as described in EP 0 884 298.

According to one or more further embodiments, the at least one surfactant S comprises an anionic surfactant and/or a non-ionic surfactant, preferably a mixture of an anionic surfactant and/or a non-ionic surfactant.

According to one or more further embodiments, the at least one surfactant S is an amphoteric surfactant, preferably selected from aminocarboxylic acids and betaines, especially fatty acid amido alkyl betaines, particularly cocamidopropyl betaine. Betaines are neutral chemical compound with a positively charged cationic functional group, such as quaternary ammonium or phosphonium cation, that bears no hydrogen atom, and with a negatively charged functional group such as a carboxylate group that may not be adjacent to the cationic site. A betaine is thus a specific type of a zwitterion. These kinds of surfactants turned out to be highly beneficial in the context of the present invention since they are highly compatible with the further constituents that are typically present in the foamed inorganic material.

The geometrical shape of the outer shell is not particularly restricted, and it depends mainly on application requirements of the insulation panel, particularly on the surface geometry of the substrate to be covered with the insulation panel. The outer shell (2) preferably comprises top and bottom walls (3, 3′) that are connected by first and second longitudinal side walls (4, 4′), preferably having an outer surface with a convex or concave shape, and an opening allowing the inner space of the outer shell (2) to be filled with the foamed inorganic material.

The top, bottom, first, and second longitudinal side walls (3, 3′, 4, 4′) of the outer shell (2) have inner and outer surfaces defining a thickness of the wall there between. The surfaces of the walls (3, 3′, 4, 4′) can be planar or corrugated over their width and/or length.

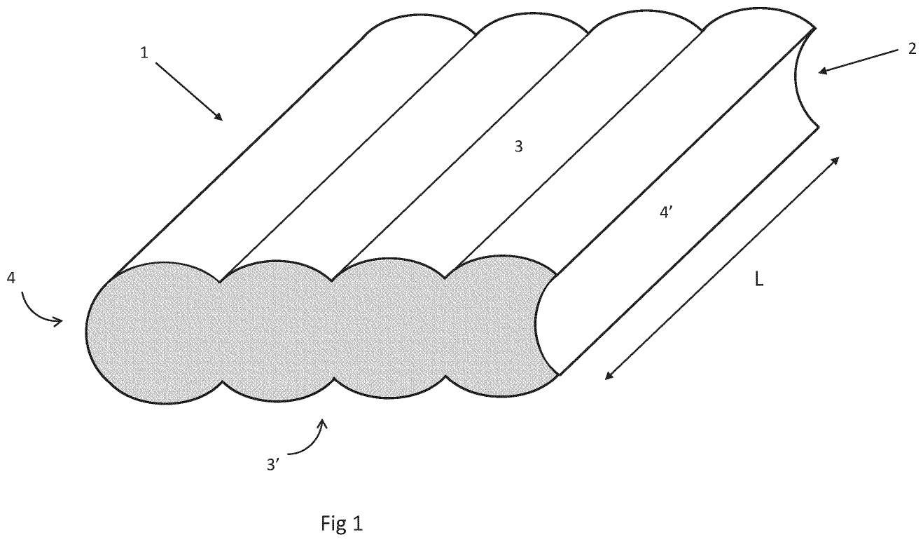

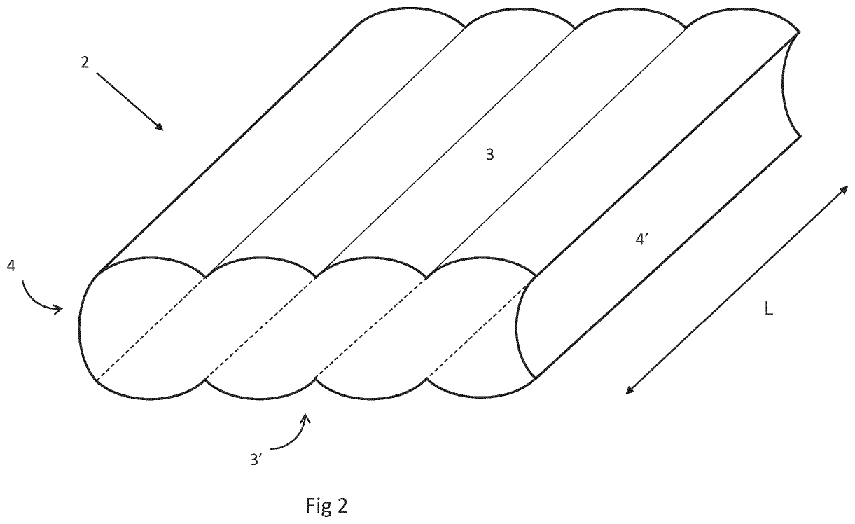

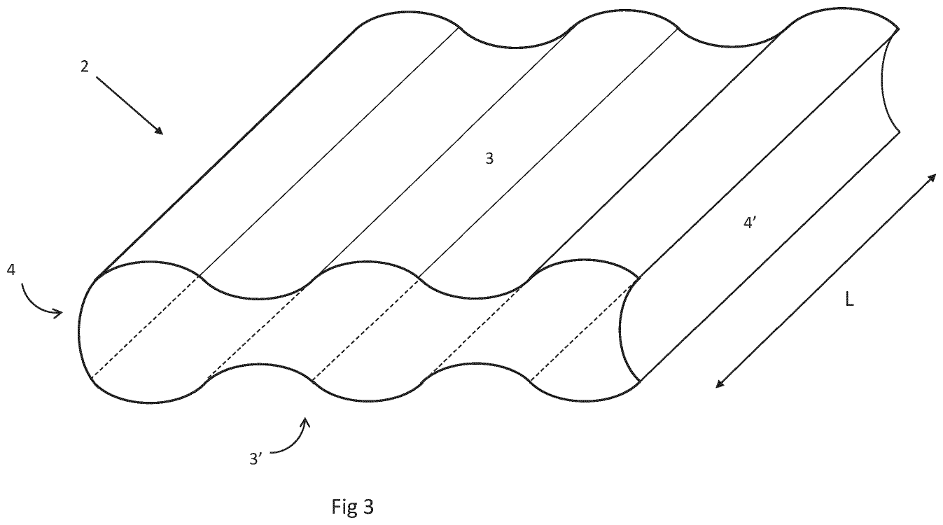

According to one or more embodiments, the outer surfaces of the longitudinal side walls (4, 4′) have a convex or concave shape. Outer shells (2) comprising longitudinal side walls (4, 4′) having an outer surface with a convex or concave shape are shown in FIGS. 1-3.

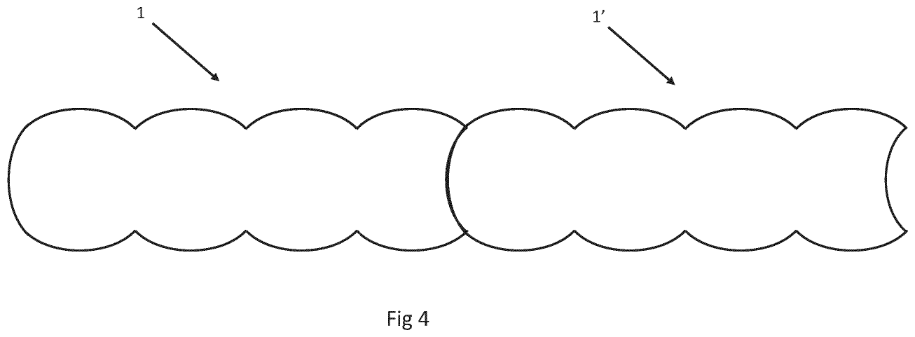

According to one or more preferred embodiments, the outer surface of one of the longitudinal side walls has a convex shape whereas the outer surface of the other longitudinal side wall has a concave shape. Providing the outer shell of an insulation panel with such longitudinal side walls enables mating engagement of adjacent insulation panels with each other via the opposing longitudinal side walls as shown in FIG. 4.

According to one or more embodiments, the longitudinal side walls (4, 4′) have a convex or concave cross-sectional shape cut into a plane perpendicular to the longitudinal direction (L) of the outer shell (2). According to one or more preferred embodiments, one of the longitudinal side walls has a convex cross-sectional shape cut into a plane perpendicular to the longitudinal direction (L) of the outer shell (2) whereas the other longitudinal side wall has a concave cross-sectional shape cut into a plane perpendicular to the longitudinal direction (L) of the outer shell (2).

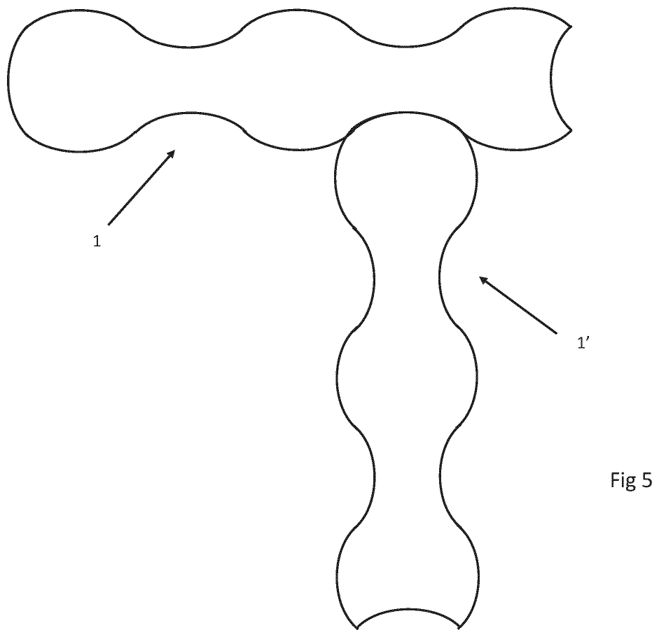

Furthermore, the top and bottom walls (3, 3′) of the outer shell (2) may be planar or have one or be corrugated to have one or more peaks and/or valleys. According to one or more embodiments, the top and/or bottom wall (3, 3′) of the outer shell (2) is corrugated over its width to have an outer surface comprising one or more convex sections and/or one or more concave sections. Providing the outer shell of an insulation panel with such top and/or bottom wall enables mating engagement of adjacent insulation panels with each other via the opposing longitudinal side wall and top or bottom wall as shown in FIG. 5.

According to one or more preferred embodiments, the top and bottom walls (3, 3′) of the outer shell (2) are corrugated over their widths to have an outer surface comprising one or more convex sections and one or more concave sections.

According to one or more embodiments, the top and/or bottom wall (3, 3′) of the outer shell (2) is corrugated over its width to have a cross-sectional shape, cut into a plane perpendicular to the longitudinal direction (L) of the outer shell (2), comprising one or more convex sections and/or one or more concave sections. According to one or more preferred embodiments, the top and bottom walls (3,3′) of the outer shell (2) are corrugated over their widths to have a cross-sectional shape, cut into a plane perpendicular to the longitudinal direction (L) of the outer shell (2), comprising one or more convex sections and one or more concave sections.

The thickness of the top, bottom, and longitudinal side walls (3, 3′, 4, 4′) may be constant or non-constant over the length and/or width of the respective wall. According to one or more embodiments, the thickness of the top, bottom, and longitudinal side walls (3, 3′, 4, 4′) is substantially constant over the length and/or width of the respective wall.

Preferably, the thickness of the top, bottom, and longitudinal side walls (3, 3′, 4, 4′) is not more than 25 mm, more preferably not more than 15 mm, even more preferably not more than 10 mm. According to one or more embodiments, the thickness of the top, bottom, and longitudinal side walls (3, 3′, 4, 4′) is in the range of 0.1-20 mm, preferably 0.25-15 mm, more preferably 0.5-10 mm, even more preferably 0.75-5 mm. Outer shells having a thickness of the walls falling within the above cited ranges can be easily produced by using conventional processing techniques for thermoplastic materials, such as extrusion, injection molding, and additive manufacturing techniques.

The preferred dimensions of the insulation panel depend on application requirements. It may be preferred that the insulation panel has a width and/or length in the range of 15-300 cm, more preferably 25-250 cm, even more preferably 35-200 cm.

It is generally preferred that the inner surface of the outer shell is operative to form a bond with the foamed inorganic material. Some thermoplastic materials are inherently operational to form a bond with mineral binder compositions whereas other materials may require subjecting the surface of the material to one or more pre-treatment steps, either by using a reactive or non-reactive primer or with a flame (“flaming”), oxofluorination, plasma, corona, or similar techniques. Adhesion of the foamed inorganic material to the outer shell of the insulation panel can also be improved by using contact layers, such as those based on adhesive compositions or porous materials, for example, non-woven or woven fabrics.

Suitable polymers for use in the thermoplastic material include, for example, polyvinylchloride, polyolefins, halogenated polyolefins, ethylene ketone esters, thermoplastic polyesters, polyamides, and acrylonitrile butadiene styrene.

Suitable polyolefins include ethylene-based polyolefins, for example, polyethylenes, and ethylene copolymers, such as copolymers of ethylene and one or more α-olefins, copolymers of ethylene and vinyl acetate, and copolymers of ethylene and acrylic esters. Further suitable polyolefins include propylene-based polyolefins, for example polypropylenes and propylene copolymers, such as copolymers propylene and one or more α-olefins. Suitable thermoplastic polyesters include, for example, polyethylene terephthalate and polybutylene terephthalate.

According to one or more embodiment, the thermoplastic material comprises at least one polymer P selected from the group consisting of polyvinylchloride, polyethylene, ethylene α-olefin copolymers, ethylene acrylic ester copolymers, ethylene vinyl acetate copolymers, polypropylene, and propylene α-olefin copolymers.

Suitable polyethylenes include, for example, very-low-density polyethylene, low-density polyethylene, linear low-density polyethylene, medium-density polyethylene, high-density polyethylene, and ultra-high-molecular-weight polyethylene, particularly low-density polyethylene, linear low-density polyethylene, medium-density polyethylene, high-density polyethylene.

Suitable ethylene α-olefin copolymers include random and block copolymers of ethylene and one or more C₃-C₂₀ α-olefin monomers, particularly one or more of propylene, 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of ethylene-derived units, based on the weight of the copolymer.

Suitable ethylene random copolymers include, for example, ethylene-based plastomers, which are commercially available, for example, under the trade name of Affinity®, such as Affinity® EG 8100G, Affinity® EG 8200G, Affinity® SL 8110G, Affinity® KC 8852G, Affinity® VP 8770G, and Affinity® PF 1140G (all from Dow Chemical Company); under the trade name of Exact®, such as Exact® 3024, Exact® 3027, Exact® 3128, Exact®3131, Exact® 4049, Exact® 4053, Exact® 5371, and Exact® 8203 (all from Exxon Mobil); and under the trade name of Queo® (from Borealis AG) as well as ethylene-based polyolefin elastomers (POE), which are commercially available, for example, under the trade name of Engage®, such as Engage® 7256, Engage® 7467, Engage® 7447, Engage® 8003, Engage® 8100, Engage® 8480, Engage® 8540, Engage® 8440, Engage® 8450, Engage® 8452, Engage® 8200, and Engage® 8414 (all from Dow Chemical Company).

Suitable ethylene-α-olefin block copolymers include ethylene-based olefin block copolymers (OBC), which are commercially available, for example, under the trade name of Infuse®, such as Infuse® 9100, Infuse® 9107, Infuse® 9500, Infuse® 9507, and Infuse® 9530 (all from Dow Chemical Company).

Suitable copolymers of ethylene and vinyl acetate include those having a content of a structural unit derived from vinyl acetate in the range of 4-95 wt.-%, preferably 6-90 wt.-%, more preferably 8-90 wt.-%, based on the weight of the copolymer. Suitable ethylene-vinyl acetate bipolymers and terpolymers, such as ethylene vinyl acetate carbon monoxide terpolymers, are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® (from Eni versalis S.p.A.), and under the trade name of Levapren® (from Arlanxeo GmbH), and under the trade name of Elvaloy® (from Dupont).

Suitable polypropylenes include, for example, isotactic polypropylene (iPP), syndiotactic polypropylene (sPP), and homopolymer polypropylene (hPP).

Suitable propylene copolymers include propylene-ethylene random and block copolymers and random and block copolymers of propylene and one or more C₄-C₂₀ α-olefin monomers, in particular one or more of 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of propylene-derived units, based on the weight of the copolymer.

Suitable propylene random and block copolymers are commercially available, for example, under the trade names of Intune®, and Versify (from Dow Chemical Company) and under the trade name of Vistamaxx® (from Exxon Mobil).

Further suitable propylene copolymers include heterophasic propylene copolymers. These are heterophasic polymer systems comprising a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Suitable commercially available heterophasic propylene copolymers include reactor blends of the base polyolefin and the polyolefin modifier, also known as “in-situ TPOs” or “reactor TPOs or “impact copolymers (ICP)”, which are typically produced in a sequential polymerization process, wherein the components of the matrix phase are produced in a first reactor and transferred to a second reactor, where the components of the dispersed phase are produced and incorporated as domains in the matrix phase. Heterophasic propylene copolymers comprising polypropylene homopolymer as the base polymer are often referred to as “heterophasic propylene copolymers (HECO)” whereas heterophasic propylene copolymers comprising polypropylene random copolymer as the base polymer are often referred to as “heterophasic propylene random copolymers (RAHECO)”. The term “heterophasic propylene copolymer” encompasses in the present disclosure both the HECO and RAHECO types of the heterophasic propylene copolymers.

Depending on the amount of the polyolefin modifier, the commercially available heterophasic propylene copolymers are typically characterized as “impact copolymers” (ICP) or as “reactor-TPOs” or as “soft-TPOs”. The main difference between these types of heterophasic propylene copolymers is that the amount of the polyolefin modifier is typically lower in ICPs than in reactor-TPOs and soft-TPOs, such as not more than 40 wt.-%, particularly not more than 35 wt.-%. Consequently, typical ICPs tend to have a lower xylene cold soluble (XCS) content determined according to ISO 16152 2005 standard as well as higher flexural modulus determined according to ISO 178:2010 standard compared to reactor-TPOs and soft-TPOs.

Suitable heterophasic propylene copolymers include reactor TPOs and soft TPOs produced with LyondellBasell's Catalloy process technology, which are commercially available under the trade names of Adflex®, Adsyl®, Clyrell®, Hiflex®, Softell®, and Hifax®, such as Hifax® CA 10A, Hifax® CA 12A, and Hifax® CA 60 A, and Hifax CA 212 A. Further suitable heterophasic propylene copolymers are commercially available under the trade name of Borsoft® (from Borealis Polymers), such as Borsoft® SD233 CF.

According to one or more embodiments, the thermoplastic material of the outer shell comprises:
A) At least 35 wt.-%, preferably at least 50 wt.-%, more preferably at least 55 wt.-%, even more preferably at least 60 wt.-%, still more preferably at least 65 wt.-%, of the at least one polymer P and
B) 1.5-65 wt.-%, preferably 2.5-50 wt.-%, more preferably 5-45 wt.-%, even more preferably 10-40 wt.-%, still more preferably 15-35 wt.-%, of at least one inorganic filler F, all proportions being based on the total weight of the thermoplastic material.

According to one or more embodiments, the at least one polymer P comprises at least one ethylene vinyl acetate copolymer P1. Preferably the at least one ethylene vinyl acetate copolymer P1 has a content of a structural unit derived from vinyl acetate of at least 5 wt.-%, more preferably at least 15 wt.-%, even more preferably at least 25 wt.-%, still more preferably at least 35 wt.-%, most preferably at least 45 wt.-%, based on the weight of the copolymer.

According to one or more embodiments, the at least one ethylene vinyl acetate copolymer P1 has a content of a structural unit derived from vinyl acetate of 5-95 wt.-%, preferably 15-90 wt.-%, more preferably 25-90 wt.-%, even more preferably 35-90 wt.-%, still more preferably 45-90 wt.-%, based on the weight of the copolymer.

According to one or more preferred embodiments, the at least one ethylene vinyl acetate copolymer P1 has a content of a structural unit derived from vinyl acetate of 35-95 wt.-%, preferably 45-95 wt.-%, more preferably 55-90 wt.-%, even more preferably 65-90 wt.-%, still more preferably 70-90 wt.-%, based on the weight of the copolymer.

Ethylene vinyl acetate copolymers having the content of a structural unit derived from vinyl acetate in the above cited ranges are especially suitable for use in the thermoplastic material of the outer shell since they have been found out to improve the ability of the outer shell to form a bond with the foamed inorganic material.

According to one or more embodiments, the at least one ethylene vinyl acetate copolymer P1 comprises at least 15 wt.-%, preferably at least 25 wt.-%, more preferably at least 35 wt.-%, still more preferably at least 50 wt.-%, of the total weight of the at least one polymer P.

Suitable compounds for use as the least one inorganic filler F include inert mineral fillers and mineral binders.

The term “inert mineral filler” refers herein to mineral fillers, which, are substantially insoluble in water and unlike mineral binders do not undergo a hydration reaction in the presence of water. Suitable inert mineral fillers include, for example, sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites.

Suitable mineral binders for use as the least one inorganic filler F include hydraulic binders, such as cement and hydraulic lime, calcium sulfate hemihydrate, anhydrite, air-hardening binders, such as non-hydrated lime, and latent hydraulic and/or pozzolanic binder materials.

According to one or more embodiments, the at least one inorganic filer F comprises or is composed of at least one inert mineral filler and/or at least one mineral binder, wherein the at least one inert mineral filler is preferably selected from the group consisting of sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites and wherein the at least one mineral binder is preferably selected from the group consisting of Portland cement, calcium aluminate cement, calcium sulfoaluminate cement, hydraulic lime, calcium sulfate hemihydrate, anhydrite, non-hydrated lime, latent hydraulic binder materials, and pozzolanic binder materials.

The at least one inorganic filler F is preferably present in the thermoplastic material in form of finely divided particles, preferably having a median particle d₅₀ size of not more than 500 μm, more preferably not more than 250 μm, even more preferably not more than 100 μm. The term “particle size” refers to the area-equivalent spherical diameter of a particle.

The term median particle size d₅₀ refers to a particle size below which 50% of all particles by volume are smaller than the d₅₀ value. A particle size distribution can be determined by sieve analysis according to the method as described in ASTM C136/C136M-14 standard (“Standard Test Method for Sieve Analysis of Fine and Coarse Aggregates).

According to one or more embodiments, the at least one inorganic filler F has a median particle d₅₀ size of 0.1-100 μm, preferably 0.1-50 μm, more preferably 0.1-25 μm, even more preferably 0.1-10 μm, still more preferably 0.1-5 μm.

According to one or more embodiments, the outer shell (2) has been obtained by an additive manufacturing process, preferably a fused filament fabrication or a fused particle fabrication process.

According to one or more preferred embodiments, the additive manufacturing process comprises:
proving a digital model of the outer shell (2) and
based on the digital model, producing the outer shell (2) by using a 3D printer, preferably a fused filament fabrication or a fused particle fabrication printer.

The preferences given above for the at least one mineral binder B, the at least one synthetic organic polymer SP, the at least one surfactant S, the at least one polymer P, and the at least one inorganic filler F apply equally to all other subjects of the present invention unless stated otherwise.

Another subject of the present invention is a method for producing an insulation panel, the method comprising steps of:
I) Providing an outer shell formed of thermoplastic material,
II) Providing a foamed inorganic composition,
III) At least partially filing an inner space inside the outer shell with the foamed inorganic composition, and
IV) Letting the foamed inorganic composition to harden,
   wherein the foamed inorganic composition comprises:
a) At least one mineral binder B,
b) Optionally at least one synthetic organic polymer SP,
c) Optionally at least one surfactant S, and
d) Water,
   and wherein the foamed inorganic composition has a density of not more than 500 g/l, preferably not more than 300 g/l.

Preferably, the at least one mineral binder B comprises at least 35 wt.-%, preferably at least 50 wt.-%, more preferably at least 65 wt.-%, even more preferably at least 75 wt.-%, of the total weight of the foamed inorganic composition.

According to one or more embodiments, the weight ratio of the amount of the at least one mineral binder B to the amount of the at least one synthetic polymer SP in the foamed inorganic composition is from 100:0 to 70:30, preferably from 100:0 to 80:20.

According to one or more embodiments, the proportion of the at least one synthetic polymer SP is 1-25 wt.-%, preferably 5-15 wt.-%, more preferably 8-12 wt.-%, with respect to the weight of the at least one mineral binder B in the foamed inorganic composition.

The foamed inorganic composition has a density of not more than 500 g/l, preferably not more than 300 g/l, more preferably not more than 250 g/l, even more preferably not more than 200 g/l, such as 25-250 g/l, preferably 35-150 g/l.

According to one or more preferred embodiments, step I) comprises:
I1) proving a digital model of the outer shell and
I2) based on the digital model, producing the outer shell by an additive manufacturing process.

The term “additive manufacturing” refers, as disclosed in ISO 52900-2015 standard, to technologies that use successive layers of material to create three-dimensional (3D) objects. In an additive manufacturing process, the material is deposited, applied or solidified under computer control based on a digital model of the 3D object to be produced, to create the 3D article. Additive manufacturing is also referred to using terms such as “generative manufacturing” or “3D printing”.

A “digital model” refers to a digital representation of a real-world object, for example of an outer shell, that exactly replicates the shape of the object. Typically, the digital model is stored in a computer readable data storage, especially in a data file. The data file format can, for example, be a computer-aided design (CAD) file format or a G-code (also called RS-274) file format. The digital model of the 3D article can be created, for example, by using a CAD software or a 3D object scanner.

In an additive manufacturing process, a 3D article is prepared using shapeless materials, for example, liquids, powders, granules, pastes, etc. and/or shape-neutral materials, for example, bands, wires, or filaments that are subjected to chemical and/or physical processes, such as melting, polymerization, sintering, curing or hardening. The main categories of additive manufacturing technologies include VAT photopolymerization, material extrusion, material jetting, binder jetting, powder bed fusion, direct energy deposition, and sheet lamination techniques.

According to one or more embodiments, the additive manufacturing process used for producing the outer shell is a fused filament fabrication or a fused particle fabrication process.

In a fused filament fabrication (FFF) process, also known as fused deposition modeling (FDM), a 3D article is produced based on a digital model of the 3D article using a polymer material in form of a filament. In a FFF process, a polymer filament is fed into a moving printer extrusion head, heated past its glass transition or melting temperature, and then deposited through a heated nozzle of the printer extrusion head as series of layers in a continuous manner. After the deposition, the layer of polymer material solidifies and fuses with the already deposited layers.

The printer extrusion head is moved under computer control to define the printed shape based on control data calculated from the digital model of the 3D article. Typically, the digital model of the 3D article is first converted to a STL file to tessellate the 3D shape and to slice it into digital layers. The STL file is then transferred to the 3D printer using custom machine software. A control system, such as a computer-aided manufacturing (CAM) software package, is used to transform the STL file into control data, which is used for controlling the printing process. Usually, the printer extrusion head moves in two dimensions to deposit one horizontal plane, or layer, at a time. The formed object and/or the printer extrusion head is then moved vertically by a small amount to start deposition of a new layer.

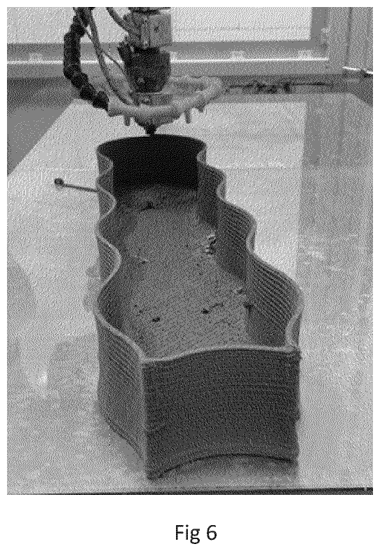

A fused particle fabrication (FPF), also known as fused granular fabrication (FGF), differs from a FFF process only in that the polymer material is provided in form of particles, such as granules or pellets, instead of a filament. An outer shell that is being produced by a fused particle fabrication process is shown FIG. 6.

According to one or more embodiments, step I2) comprises steps of:
I21) Feeding the thermoplastic material into a 3D printer, preferably a fused filament fabrication or a fused particle fabrication printer,
I22) Heating the thermoplastic material to provide a melted polymer material,
I23) Depositing the melted polymer material by using a printer extrusion head of the 3D printer in a selected pattern in accordance with the digital model of the 3D article to form the 3D article.

Step II) of the method for providing the foamed inorganic material can be conducted before or simultaneously with the step III) of filling the inner space of the outer shell with the foamed inorganic material. According to one or more preferred embodiments, the step II) is conducted before step III).

According to one or more embodiments, step II) comprises:
separately providing an aqueous foam and an aqueous slurry comprising the at least one mineral binder B and optionally the at least one synthetic organic polymer SP and
mixing the aqueous foam with the aqueous slurry to obtain the foamed inorganic composition.

The at least one synthetic organic polymer SP, if used, is preferably present in the aqueous slurry as a dispersed polymer.

The aqueous slurry can be obtained by providing the at least one synthetic organic polymer SP in form of an aqueous polymer dispersion and/or in form of a re-dispersible polymer powder and mixing the aqueous polymer dispersion and/or the re-dispersible polymer powder with the at least one mineral binder B, optionally with additional water, using any conventional mixing technique.

An aqueous polymer dispersion of at least one synthetic organic polymer SP can be prepared, for example, by free-radical polymerization using substance, solution, suspension or emulsion polymerization techniques, which are all known to the person skilled in the art, or by mixing a re-dispersible polymer powder(s) with water. Aqueous polymer dispersions comprising two or more different synthetic organic polymers SP can be easily prepared by using mixtures of commercially available aqueous polymer dispersions and/or re-dispersible polymers.

Suitable aqueous polymer dispersions are commercially available, for example
from Synthomer (UK) limited under the trade name of Lipaton®, such as Lipaton® SB 2540, Lipaton® SB 3040, and Lipaton® SB 2740 (styrene butadiene copolymers) and under the trade name of Plextol®, such as Plextol E 303 and Plextol X 4002 (pure acrylics);
from Celanese under the trade name of Mowilith®, such as Mowilith® LDM 7978 (acrylic) and Mowilith® LDM 7651 (styrene acrylic);
from BASF under the trade name of Acronal®, such as Acronal® V 278 (acrylate), Acronal® V 212 (acrylate), Acronal® 81 D (acrylate), Acronal® 4 F (acrylate), Acronal® DS 5017 (pure acrylate), and Acronal® A 107 (pure acrylate);
from Airproducts under the trade name of Airflex®, such as Airflex® EF811 (vinyl acrylic copolymer);
from Arkema under the trade name of Encor®, such as Encor® flex 187 (acrylic), Encor® 123 (styrene acrylic), Encor® flex 192 (styrene acrylic), and Encor® 9176 (styrene acrylic);
from Wacker Chemie under the trade name of Vinnapas®, such as Vinnapas® EAF 60 and Vinnapas® EAF 67 (vinyl acetate/ethylene/acrylate polymer); and
from Dow Chemicals under the trade name of Primal®, such as Primal® CA-162 and Primal® CA-172 (acrylic).

It may be preferably to use the at least one synthetic organic polymer SP in form a re-dispersible polymer powder for obtaining the aqueous slurry. Re-dispersible polymer powders are generally produced by spray-drying techniques from aqueous polymer dispersions. Re-dispersible polymer powders may further comprise one or more compounds selected from colloidal stabilizers and antiblocking agents. Examples of re-dispersible polymer powders and methods for producing thereof are disclosed, for example, in patent application US 2005/0014881 A1.

Suitable re-dispersible polymer powders are commercially available, for example
from Wacker Chemie under the trade name of Vinnapas®, such as Vinnapas® 2000 series, Vinnapas® 3000 series, Vinnapas® 4000 series, Vinnapas® 5000 series, Vinnapas® 7000 series, and Vinnapas® 8000 series; and
from Synthomer under the trade name of Axilat®, such as Axilat® HP 8000 series, Axilat® UP series, Axilat® PSB 150 (styrene butadiene copolymer), and Axilat® PAV series (vinyl acetate vinyl versatate copolymer).

The aqueous foam comprises or consists of gaseous bubbles enclosed by liquid walls. The gas of the bubbles can be any type of gas, such as air, nitrogen, carbon dioxide, a noble gas, or mixtures thereof, preferably air.

The aqueous foam is preferably prepared by mechanical foaming of an aqueous mixture in the presence of a gas, particularly air, nitrogen and/or carbon dioxide and/or a noble gas. Mechanical foaming refers to a method in which the gaseous bubbles are introduced into the water of the aqueous foam by mixing the gas with water without performing any gas producing chemical reactions.

Particularly, the foaming is conducted in absence of chemically acting pore-forming agents and/or chemically acting foaming agents. In absence of a chemically acting pore-forming agent and/or a chemically acting foaming agent means that a proportion the chemically acting pore-forming agent and/or the chemically acting foaming agent is lower than 0.1 wt.-%, especially lower than 0.01 wt.-%, particularly lower than 0.001 wt.-%, with respect to the weight of the water of the aqueous foam. Most preferably, there is no chemically acting pore-forming agent and/or chemically acting foaming agent present.

According to one or more embodiments, the aqueous foam is obtained by mechanical foaming an aqueous mixture with gas, preferably with air.

Preferably, the aqueous foam comprises the at least one surfactant S, preferably an anionic surfactant and/or a non-ionic surfactant. Surfactants help to stabilize the foam structure of the aqueous foam. It may be preferred that the at least one surfactant S is provided in the aqueous mixture before foaming.

The at least one surfactant S preferably comprises 0.001-10 wt.-%, more preferably 1-4 wt.-%, even more preferably 2-3 wt.-%, of the total weight of the aqueous foam.

According to one or more embodiments, the aqueous slurry further comprises at least on solid filler SF. Suitable compounds for use as the at least one solid filler SF include inorganic, organic, and synthetic organic materials that do not undergo a hydration reaction in the presence of water and that are substantially insoluble in water. Particularly, the at least one solid filler SF is chemically and/or physically different from the other constituents of the foamed inorganic composition.

Preferably, the at least one solid filler SF has a water-solubility of less than 0.1 g/100 g water, more preferably less than 0.05 g/100 g water, even more preferably less than 0.01 g/100 g water, at a temperature of 20° C. The solubility of a compound in water can be measured as the saturation concentration, where adding more compound does not increase the concentration of the solution, i.e., where the excess amount of the substance begins to precipitate. The measurement for water-solubility of a compound in water can be conducted using the standard “shake flask” method as defined in the OECD test guideline 105 (adopted 27^{th} Jul. 1995).

The particle size of the at least one solid filler SF is not particularly restricted and submicron-sized particles, micrometer-sized particles, millimeter-sized particles up to centimeter-sized particles are all suitable.

Preferably, the at least one solid filler SF has maximum particle size of not more than 20 mm, more preferably not more than 5 mm, even more preferably not more than 2.5 mm, still more preferably not more than 1.5 mm.

According to one or more embodiments, the at least one solid filler SF is selected from the group consisting of sand, limestone, artificial stone, quartz flour, quartz sand, baryte, talc, dolomite, wollastonite, mica, perlite, pumice, vermiculite, norlite, fly ash, micro silica, kaolin, metakaolin, silica fume, fumed silica, granulated blast-furnace slag, foamed blast furnace slag, volcanic slag, expanded clay, expanded shale, expanded slate, foamed glass, pozzolans, diatoms, ceramic particles, ceramic spheres, and porous silica.

Preferably, a proportion of the at least one solid filler SF is 0.001-25 wt.-%, more preferably 0.001-10 wt.-%, still more preferably 0.001-5 wt.-%, with respect to the total weight of the at least one mineral binder B in the aqueous slurry.

According to one or more embodiments, the aqueous slurry further comprises at least one plasticizer PL. Suitable plasticizers are liquid inert organic substances having a low vapor pressure, preferably having a boiling point of above 200° C. measured at a pressure of 1 bar.

According to one or more embodiments, the at least one plasticizer PL is selected from the group consisting of lignosulfonates, gluconates, naphtalenesulfonates, melamine sulfonates, vinyl copolymers, polycarboxylate ethers, adipic and sebacic acid plasticizers, phosphoric acid plasticizers, citric acid plasticizers, fatty acid esters and epoxidised fatty acid esters, benzoates, phthalates, and esters of 1,2-dicarboxy cyclohexane. Polycarboxylate ethers are mentioned as preferred plasticizers. Particularly, the at least one plasticizer PL is chemically different from the at least one synthetic organic polymer SP.

A proportion of the at least one plasticizer PL, especially of the polycarboxylate ether, is preferably 0.001-5 wt.-%, more preferably 0.01-1 wt.-%, with respect to the total weight of the at least one mineral binder B in the aqueous slurry.

Furthermore, other additives may be added to the aqueous foam and/or to the aqueous slurry.

Such additives may be thickening agents, viscosifying agents, accelerators, setting retarders, colored pigments, hollow glass beads, film forming agents, hydrophobic agents or de-polluting agents, for example zeolites or titanium dioxide, latex, organic or mineral fibers, mineral additions or their mixtures. Preferably, the additives do not comprise any defoaming agents.

The term “thickening agent”, is generally to be understood as any compound making it possible to maintain the heterogeneous physical phases in equilibrium or facilitate this equilibrium. Suitable thickening agents are preferably gums, cellulose or its derivatives, for example cellulose ethers or carboxy methyl mellulose, starch or its derivatives, gelatine, agar, carrageenans and/or bentonite clays.

Accelerators for hydraulic binders are well known, and any solidification and hardening accelerators may be used in the present invention. For example, the accelerator may be selected from aluminum hydroxide, aluminum sulphate, carboxylic acids, metal oxides, metal hydroxides, inorganic acids, alkali hydroxide, alkali metal silicates nitrates, and/or nitrites. Particularly advantageous accelerators include aluminum-containing accelerators, such as aluminum sulphate.

Preferably, the accelerator, especially an aluminum compound, may be used in an amount of 0.15-5 wt.-%, preferably 0.25-3 wt.-%, especially 0.5-2.5 wt.-%, with respect to the total weight of the at least one mineral binder B in the aqueous slurry.

The aqueous foam and the aqueous slurry of the mineral binder B are preferably mixed with each other under overpressure conditions. Preferably, at an overpressure of 1-15 bar, especially 2-5 bar, with respect to the environmental air pressure. This allows for easily adjusting the density of the foamed mineral binder composition in wide ranges.

Most preferably, the mixing is conducted using a static mixer, whereby, preferably, the aqueous foam and the aqueous slurry of the mineral binder B are driven by pressurized air through the static mixer. Preferably, the pressurized air has a pressure of 1-15 bar, especially 6-10 bar, above the environmental air pressure. Thereby, a stable foamed mineral binder composition is obtainable in a reliable manner. The aqueous foam may be mixed with the slurry either batch-wise or continuously.

The weight ratio of water to the at least one mineral binder B in the aqueous slurry is preferably 0.2-0.7, more preferably 0.25-0.5, even more preferably 0.3-0.4.

1. An insulation panel comprising an outer shell formed of a thermoplastic material and an inner space inside the outer shell, wherein the inner space is at least partially filled with a foamed inorganic material comprising:
a) at least one mineral binder
b) optionally at least one synthetic organic polymer,
wherein the foamed inorganic material has a density of not more than 500 g/l.

2. The insulation panel according to claim 1, wherein the at least one mineral binder comprises at least 35 wt.-% of the total weight of the foamed inorganic material.

3. The insulation panel according to claim 1, wherein the at least one mineral binder is selected from the group consisting of Portland cement, calcium aluminate cement, calcium sulfoaluminate cement, latent hydraulic binder materials, pozzolanic binder materials, calcium sulfate, and hydrated lime.

4. The insulation panel according to claim 1, wherein the weight ratio of the amount of the at least one mineral binder to the amount of the at least one synthetic polymer in the foamed inorganic material is from 100:0 to 70:30.

5. The insulation panel according to claim 1, wherein the at least one synthetic polymer is selected from the group consisting of polyacrylates, styrene-acrylate copolymers, polyvinyl esters, ethylene-vinyl acetate copolymers, ethylene-vinyl alcohol copolymers, styrene-butadiene copolymers, vinyl acetate-vinyl neodecanoate (VeoVa) copolymers, and polyurethane polymers.

6. The insulation panel according to claim 1, wherein the outer shell comprises an opening and top and bottom walls connected by first and second longitudinal side walls, wherein the longitudinal side walls have an outer surface having a convex or concave shape.

7. The insulation panel according to claim 6, wherein top and/or bottom wall of the outer shell is corrugated over its width to have an outer surface having one or more convex sections and/or one or more concave sections.

8. The insulation panel according to claim 1, wherein the thermoplastic material of the outer shell comprises at least one polymer.

9. The insulation panel according to claim 8, wherein the thermoplastic material of the outer shell comprises:
A) at least 35 wt.-% of the at least one polymer and
B) 1.5-65 wt.-% of at least one inorganic filler, all proportions being based on the total weight of the thermoplastic material.

10. The insulation panel according to claim 8, wherein the at least at least one polymer comprises at least one ethylene vinyl acetate copolymer.

11. The insulation panel according to claim 1, wherein the outer shell has been obtained by an additive manufacturing process.

12. A method for producing an insulation panel comprising steps of:
I) providing an outer shell of a thermoplastic material,
II) providing a foamed inorganic composition,
III) at least partially filing an inner space inside the outer shell with the foamed inorganic composition, and
IV) letting the foamed inorganic composition to harden,
wherein the foamed inorganic composition comprises:
a) at least one mineral binder and
b) optionally at least one synthetic organic polymer,
c) optionally at least one surfactant, and
d) water,
wherein the foamed inorganic composition has a density of not more than 500 g/l.

13. The method according to claim 12, wherein the at least one mineral binder comprises at least 35 wt.-% of the total weight of the foamed inorganic composition.

14. The method according to claim 12, wherein the weight ratio of the amount of the at least one mineral binder to the amount of the at least one synthetic polymer in the foamed inorganic composition is from 100:0 to 70:30.

15. The method according to claim 12, wherein step I) comprises:
I1) providing a digital model of the outer shell and
I2) based on the digital model, producing the outer shell by an additive manufacturing process.

16. The method according to claim 15, wherein the additive manufacturing process is a fused filament fabrication or a fused particle fabrication process.

17. The method according to claim 12, wherein step II) comprises:
separately providing an aqueous foam and an aqueous slurry comprising the at least one mineral binder and optionally the at least one synthetic organic polymer and
mixing the aqueous foam with the aqueous slurry to obtain the foamed inorganic composition.
